(19) United States
(12) Patent Application Publication
(10) Pub. No.: US 2017/0161656 A1
(43) Pub. Date: Jun. 8, 2017

(54) RISK PREPARATION DEVICE, RISK PREPARATION METHOD, AND RISK PREPARATION SYSTEM

(71) Applicant: Panasonic Intellectual Property Management Co. Ltd., Osaka (JP)

(72) Inventor: Hisashi TAKAYAMA, Tokyo (JP)

(21) Appl. No.: 15/324,075

(22) PCT Filed: Jul. 10, 2015
(86) PCT No.: PCT/JP2015/003489

§ 371 Date: Jan. 5, 2017

(30) Foreign Application Priority Data
Jul. 11, 2014 (JP) 2014-143307

(51) Int. Cl. G06Q 10/06

(52) U.S. Cl. CPC G06Q 10/0635

(57) ABSTRACT

A risk preparation device includes an information obtainer, a plan generator, a storage, and a plan executer. The information obtainer receives prediction information predicting an occurrence of a risk. The storage stores, in association with the type and the level of a risk included in the prediction information, details of preparation work for equipment provided in a building. The plan generator generates, based on the prediction information, operation plans for the equipment to implement the details of the preparation work before the risk occurs. The plan executer instructs operations to equipment in accordance with the operation plans.

### TECHNICAL FIELD

The present invention relates to a risk preparation device, a risk preparation method, and a risk preparation system which carry out preparations for a risk.

### BACKGROUND ART

There is proposed a technique in which the amount of charge accumulated in a secondary battery provided to back up power supply is increased above the amount of charge in a steady state, when a prediction for the occurrence of a disaster in which stoppage of main power supply is anticipated is obtained (see for example Patent Literature (PTL) 1). PTL 1 discloses using a secondary battery as a back up and increasing the amount of charge accumulated in the secondary battery above the amount of charge in a steady state, after a disaster occurrence prediction is obtained.

### CITATION LIST

### Patent Literature

PTL 1: Japanese Unexamined Patent Application Publication No. 2009-148070

### SUMMARY OF THE INVENTION

### Technical Problem

However, in response to a disaster occurrence prediction, PTL 1 only controls the secondary battery, and merely focuses on the amount of charge to be stored in the secondary battery.

The present invention has as an object to provide a risk preparation device, a risk preparation method, and a risk preparation system which carry out preparations to enable risk effect reduction or avoidance.

### Solution to Problem

A risk preparation device according to an aspect of the present invention includes: an information obtainer which obtains prediction information predicting an occurrence of a risk; a storage which stores, in association with details of the prediction information, details of preparation work for equipment provided in a building; a plan generator which generates an operation plan for the equipment based on the prediction information, to implement the details of the preparation work by a time the risk occurs; and an outputter which outputs the operation plan.

A risk preparation method according to an aspect of the present invention includes: obtaining prediction information predicting an occurrence of a risk; storing, in association with details of the prediction information, details of preparation work for equipment provided in a building; generating an operation plan for the equipment based on the prediction information, to implement the details of the preparation work by a time the risk occurs; and outputting the operation plan.

A risk preparation system according to an aspect of the present invention includes an information obtainer which obtains prediction information predicting an occurrence of a risk; a storage which stores, in association with details of the prediction information, details of preparation work for equipment provided in a building; a plan generator which generates an operation plan for the equipment based on the prediction information, to implement the details of the preparation work by a time the risk occurs; and an outputter which outputs the operation plan.

### Advantageous Effects of Invention

According to the configuration of the present invention, details of preparation work to enable risk effect reduction or avoidance are determined, and an operation plan for equipment for implementing the details of the preparation work is generated. Specifically, in response to a risk such as a disaster and air pollution, an operation plan for controlling equipment is generated according to details of preparation work which serve as a targets determined to enable risk effect reduction or avoidance, so that a state equivalent to the details of the preparation work can be obtained. In this manner, since the target state and the details of control in order to achieve the target state are separated, it is possible to generate an operation plan that does not greatly impair convenience and economical efficiency while achieving the target state.

### BRIEF DESCRIPTION OF DRAWINGS

FIG. 1 is a block diagram illustrating Embodiment 1.

FIG. 2 is a diagram for describing operation according to Embodiment 1.

FIG. 3 is a diagram illustrating an example operation of equipment in Embodiment 1.

FIG. 4 is a block diagram illustrating Embodiment 2.

FIG. 5 is a block diagram illustrating Embodiment 3.

### DESCRIPTION OF EXEMPLARY EMBODIMENTS

Hereinafter, a risk preparation device configured with the purpose of reducing or avoiding a risk such as a disaster will be described. The risk preparation device is provided in a building. In the embodiments described below, one condition of the object risk is that occurrence time can be predicted with relatively high reliability. Furthermore, conditions for the object risk also include the condition that the period from prediction time to occurrence time of the risk is a period that allows for preparations for risk effect reduction or avoidance.

For example, typhoons, thunderstorms, tornados, tsunamis following an earthquake that occurred at a distance, etc., are included in the type of risk that can cause damage to public utilities such as power, gas, and water. Furthermore, air pollutants, etc., are included in the type of risk that can be detrimental to human health. Air pollutants of this type include nitrogen oxide, sulfur oxide, yellow dust, particulate matter, etc. Although these risks are different in terms of type, the occurrence time of these risks can be predicted one hour to several days in advance, with relatively high reliability.

On the other hand, techniques for preparing for risks include the examples described below. For example, in the case of a user that can avail the use of a storage battery, carrying out preparation to increase the battery residual of the battery by the risk occurrence time makes it possible to reduce risk by using storage battery power during the period in which the power utility is damaged. Furthermore, in the case of a user using a storage-type water heater of a bath with an automatic hot water filling function, preparation is carried out to increase the amount of water stored in a hot water storage tank or bathtub by the risk occurrence time. With this preparation, risk can be reduced by using the water in the hot water storage tank or bathtub during the period in which the water utility is damaged. In the case where a window or a ventilation hole serving as a ventilation device is electrically operated, carrying out preparation to close the window or ventilation hole by the risk occurrence time makes it possible to mitigate the amount of yellow dust, particulate matter, air pollutants, etc., entering the room.

If a risk is predictable and preparation to reduce or avoid the effects of such risk is possible, various combinations of risk type and preparation type are possible, aside from the examples described above. Furthermore, although these preparations can be carried out by hand, it is assumed in the subsequent description that preparation work is carried out automatically.

It should be noted that preparation work includes cases requiring a relatively long preparation period and cases that only require a relatively short preparation period. For example, charging a storage battery requires a relatively long time of about several hours, accumulating water in a hot water storage tank or a bathtub requires an intermediate amount of time in the tens of minutes, and closing a window or a ventilation hole can be performed in a relatively short time of a few minutes. Therefore, it is necessary to consider the time required for preparation work and select the type of preparation work in accordance with the period from the prediction time to the occurrence time of the risk.

The risk preparation device described below includes, as main hardware elements, a processor that operates according to a program, and an interface. Other than a configuration requiring a separate memory, the device including the processor may be a microcontroller that integrally includes a memory. The type of the device does not matter as long as it is a device that is equivalent to a processor and is capable of realizing the subsequently described risk preparation device by executing a program.

The program is provided using a read-only memory (ROM) or provided using a computer-readable recoding medium. Furthermore, the program may be provided via an electronic communication channel such as the Internet or a mobile telephone network.

### Embodiment 1

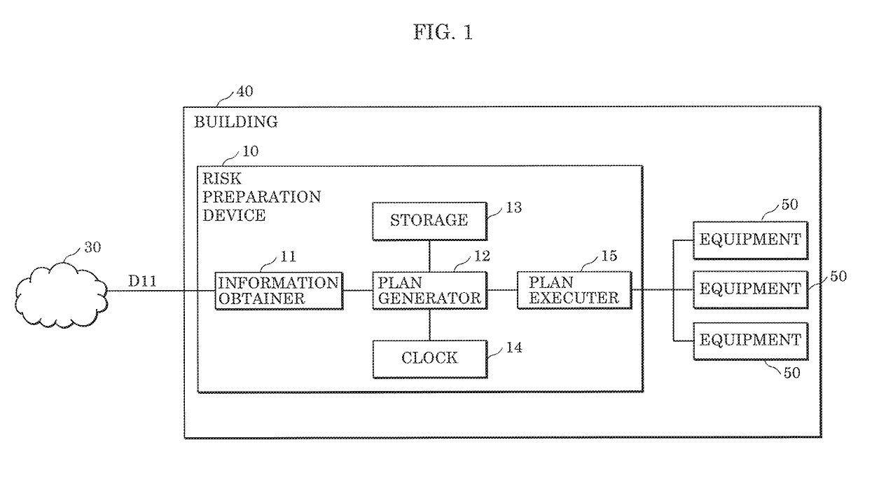

As illustrated in FIG. 1, risk preparation device 10 according to this embodiment includes information obtainer 11 which obtains prediction information D11 regarding a risk. Although a configuration that obtains prediction information D11 through electronic communication channel 30 such as the Internet is assumed for information obtainer 11, a configuration that receives an emergency warning broadcast may be included. In this embodiment, various disasters, air pollutants, etc., such as those described above are assumed for the types of risks.

Prediction information D11 which predicts these risks is issued by government agencies, municipalities, authorized forecasters, etc. Information obtainer 11 obtains prediction information D11 through electronic communication channel 30, broadcasts, etc. For risks having a limited occurrence area such as thunderstorms and tornados, the parameters included in prediction information D11 include type, level, area, period, etc. On the other hand, for risks where route and speed are predicted such as typhoons, the parameters included in prediction information D11 may include route and speed in place of area and period.

It should be noted that the level of the risk means the predicted magnitude of the effect. The level of the risk is classified into a plurality of stages, and it is determined whether the extent of the predicted effect is within an allowable range that does not pose a danger to lives and there is a possibility of causing damage to public utilities such as power, gas, water, etc., or whether there is a possibility of causing damage to a person's health. Stated differently, for a risk having a higher level that does not satisfy these conditions, it is necessary to evacuate without carrying out preparations. In contrast, for a risk having a lower level that does not satisfy these conditions, it is necessary to carry out preparations. Stated differently, whether or not preparation is to be carried out in response to a risk is determined according to the level of the risk.

When the risk type is typhoon, the central pressure of the typhoon, for example, is used to indicate the levels. As an example, the central pressure is classified into, less than 930 hPa, 930 hPa to 960 hPa, 960 to 980 hPa, greater than 980 hPa, etc. For typhoons, the levels can also be classified according to maximum wind speed, size (the radius of a strong wind area having a wind speed of at least 15 m/s), forecast rainfall, etc.

The details of preparation for a risk differ according to the type and level of the risk. Furthermore, the details of preparation are also different depending on equipment 50 provided in building 40 in which risk preparation device 10 is provided. This embodiment assumes the case where, among equipment 50 provided in building 50, equipment 50 which enable reduction or avoidance of risk effects are the four types, namely, a storage battery, a storage-type water heater, a bath having an automatic hot water filling function, and a ventilation hole. These equipment 50, however, are not intended to limit the types of equipment 50, and are only given as representative examples. It is acceptable to use only equipment 50 of any one type, or other equipment 50 can also be used.

Now, it is assumed that equipment 50 provided for a typhoon is a storage battery, and the level is classified according to central pressure. In this case, the details of preparation is assumed to be, for example, charging up to a full charge if the central pressure is less than 930 hPa, and charging up to a battery residual that is set to be less than a full charge (upper limit Ls2 in FIG. 3) if the central pressure is between 930 hPa to 950 hPa. If the storage battery is a lithium ion battery, upper limit Ls2 is set to be greater than a battery residual that is set in consideration of battery life and less than a full charge (upper limit Ls1 in FIG. 3). In addition, for example, the details of preparation may be set so that preparation of charging up to the battery residual set in consideration of battery life is carried out if the central pressure is between 960 hPa to 980 hPa, and preparation provided for the typhoon is not carried out if the central pressure is greater than 980 hPa.

Whether or not preparation for reducing or avoiding risk is to be carried out in response to prediction information D11 obtained by information obtainer 11 is determined by plan generator 12 with reference to the content of storage 13 and a date and time clocked by clock 14. Clock 14 is implemented by, for example, a real-time clock.

Storage 13 stores a rule in which details of preparation work (equipment 50 to be used in preparation, the state of equipment 50) are associated with the type and the level, among the parameters (type, level, area, period) included in prediction information D11. This rule is a production rule, and a rule having prediction information D11 as conditions and the details of preparation work as conclusions is stored in advance in storage 13. The details of preparation, which are conclusions of the rule, is to evacuate when the level exceeds the upper limit of the allowable range, and not to carry out the preparation when the level is below the lower limit of the allowable range.

Since the range of the time difference from when prediction information D11 is issued to when the predicted risk occurs is practically determined according to the type of the risk, the aforementioned rule is set so that the type of a usable preparation work is associated with the risk type and level which serve as conditions.

However, the rule may be set to include, as a condition, the time difference between the start time of the period included in prediction information D11 and the time that is clocked by clock 14. This time difference is equivalent to the time from the point in time when the risk is predicted to the point in time when the risk occurs. The time required by the preparation work to prepare for the risk is different depending on the type of the preparation work. Therefore, by using a rule in which the aforementioned time difference is included in the conditions, the type of the preparation work can be appropriately determined.

When plan generator 12 receives prediction information D11 from information obtainer 11, plan generator 12 checks prediction information D11 in storage 13. When the location area of building 40 is included in prediction information D11, plan generator 12 checks the type and the level of the risk included in prediction information D11 with the rule stored in storage 13, and extracts the details of the preparation work.

It should be noted that, since there are cases in which a long time is required depending on the type of the preparation work, plan generator 12 may calculate the time difference between the date and time of the predicted time clocked by clock 14 and the start time of the period included in prediction information D11, and check the calculated time difference with the rule in storage 13. Obviously, in this case, a time difference is set in the conditions of the rule.

Information regarding the location area of building 40 is set in plan generator 12, and, when the area included in prediction information D11 is included in the location area of building 40, the period in which the risk occurs is determined based on the period included in prediction information D11. It should be noted that in the case of a risk such as a typhoon where prediction information D11 includes route and speed, the period in which the risk will occur in the location area of building 40 is determined based on the route and the speed.

In addition, plan generator 12 checks the type and level of the risk included in prediction information D11 with the rule in storage 13, and extracts the details of the preparation work corresponding to the type and level of the risk. The details of the preparation work includes the type of equipment 50 that is to carry out the preparation for the risk, and the state of such equipment 50 that should be attained by the time the risk occurs. In view of this, plan generator 12 generates an operation plan for equipment 50 such that equipment 50 extracted as a detail of the preparation work is in the state that should be attained by the time the risk occurs. Here, the operation plan is generated by performing a simulation regarding the operation of equipment 50. A specific example of the operation plan of equipment 50 will be described later.

The operation plan for equipment 50 which was generated by plan generator 12 is transmitted to plan executer 15 which serves as an outputter. Plan executer 15 controls the operation of equipment 50 so that equipment 50 is in the state that should be attained by the time the risk occurs. Specifically, plan executer 15 is an outputter which gives instructions from risk preparation device 10 to equipment 50. The details of the instruction are outputted according to the details of the operation plan.

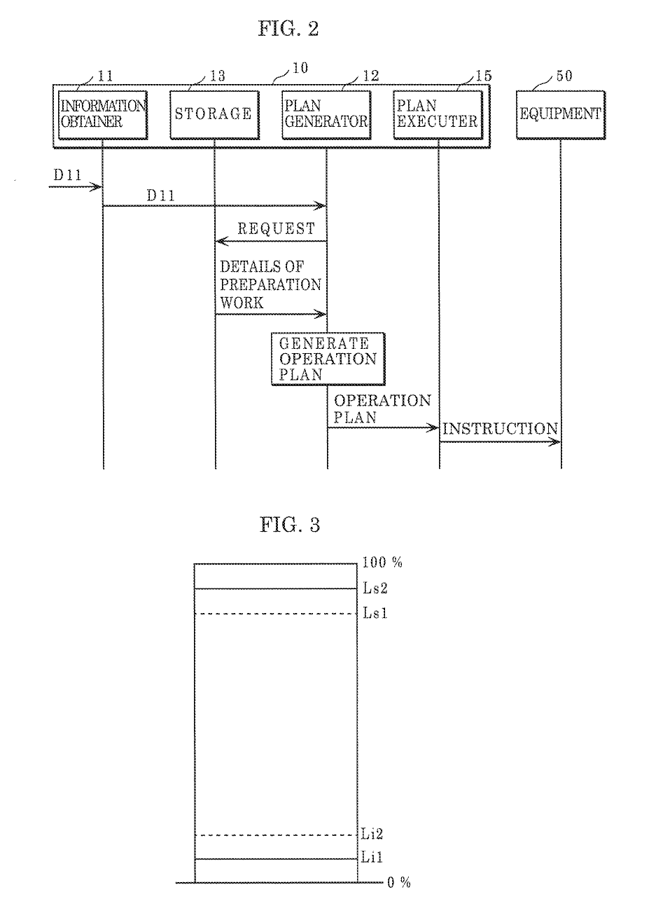

A consolidation of the above-described operations is illustrated in FIG. 2. Specifically, when information obtainer 11 receives prediction information D11, information obtainer 11 transmits prediction information D11 to plan generator 12. Plan generator 12 checks prediction information D11 with storage 13, and storage 13 returns details of preparation work to plan generator 12, based on the rule corresponding to prediction information D11. Plan generator 12 generates an operation plan according to the details of the preparation work obtained from storage 13, and transmits the operation plan to plan executer 15. Plan executer 15 instructs operations to equipment 50 in accordance to the operation plan.

When a storage battery is included in equipment 50 to be controlled according to the operation plan, it is preferable that the battery residual of the storage battery is to be increased as much as possible in the operation plan. When a lithium ion battery is used for the storage battery, charging and discharging is controlled so that the charging rate (battery residual with respect to nominal capacity) is kept between, for example, 40% to 80% in order to suppress deterioration of the storage battery. For example, as illustrated in FIG. 3, it is assumed that in normal times the battery residual upper limit and the battery residual lower limit are kept at Ls1 and is Li1, respectively.

On the other hand, in the period in which a risk occurs, it is desirable to have as much power accumulated in the storage battery available for use. As such, in the operation plan for the preparation work, battery residual upper limit Ls2 is set higher than the normal upper limit Ls1 (Ls1<Ls2), and in a period in which the storage battery is discharged in response to a risk, battery residual lower limit Li2 is set lower than the normal lower limit Li1 (Li1>Li2). Through such an operation, available power in the storage battery can be increased above normal. It should be noted that, as described above, when the level of a risk is high, there are instances where a full charge is allowed.

When a storage-type water heater is included in equipment 50 to be controlled according to the operation plan, it is preferable that the remaining amount of water stored in the hot water storage tank be increased as much as possible in the operation plan. Unlike a lithium ion battery and the like, in the case of a hot water storage tank, it is preferable that the hot water storage tank be placed in a full state. When a bath having an automatic hot water filling function is included in equipment 50 to be controlled according to the operation plan, it is preferable that the bathtub be placed in a full state, as in the case of the hot water storage tank.

When a ventilation device such as window or ventilation hole in which opening and closing is operated electrically is included in equipment 50 to be controlled according to the operation plan, the operation plan is generated so as to close the window or ventilation hole.

With the examples of equipment 50 described above, it is possible to prepare for a risk by performing the above-described operations according to the operation plan by the time the risk occurs.

Now, it is assumed that the risk is a typhoon and prediction information D11 including information on route and speed is obtained by information obtainer 11. Furthermore, it is assumed that the rule in storage 13 is determined such that, when the risk type is typhoon, operation work regarding the storage battery and the storage-type water heater which serve as equipment 50 is performed. In addition, it is assumed that the state that should be attained for the storage battery is the fully charged state, and the state that should be attained for the storage-type water heater is the full state of the hot water storage tank.

When plan generator 12 receives prediction information D11 from information obtainer 11, plan generator 12 calculates the period during which the effect of the typhoon is felt in the location area of building 40, based on the information on route and speed included in prediction information D11. Furthermore, plan generator 12 generates an operation plan for the storage battery and the storage-type water heater with reference to the rule stored in storage 13 so that the storage battery is placed in the fully charged state and the hot water storage tank is placed in the full state by the time the effect of the typhoon is felt. It should be noted that the fully charged state includes the state where the battery residual reaches the second upper limit value described using FIG. 3.

The operation plan generated by plan generator 12 is generated for the period from when prediction information D11 is received to when the effect of the typhoon is felt. Therefore, the operation plan is generated with consideration given to the battery residual of the storage battery and the amount of water in the hot water storage tank at the time when prediction information D11 is received and to the period from when prediction information D11 is received to when the effect of the typhoon is felt.

Here, since it is sufficient that the storage battery is in the fully charged state and the hot water storage tank is in the full state by the time the effect of the typhoon is felt, the power of the storage battery and the hot water of the hot water storage tank can be provided for use if the time up to when the effect of the typhoon is to be felt is relatively long. Furthermore, assuming that a solar power generator is provided in building 40, and the generated power of the solar power generator is used for charging the storage battery and for selling electricity, it is sufficient that the operation plan be generated so that the generated power of the solar power generator is used solely for charging when there is concern over the effect of the typhoon. In this manner, the operation plan is generated with consideration to economical efficiency and convenience.

In the example configuration described above, the details of the preparation work serving as the conclusion of the rule stored in storage 13 include equipment 50 to be used in the preparation and the state of such equipment 50. In addition to these details, the conclusions of the rule may include the timing for attaining the state. Specifically, the conclusions of the rule may include information about the point in time at which the state is to be attained, which is ahead of the point in time at which the effects of the risk is predicted to be felt. In other words, the conclusions of the rule may include information on how much earlier the state should be attained before the point in time when the effect of the risk is felt. Information of this type is set for each equipment 50, in the same manner as the state to be attained by equipment 50. When information of this type is included in the rule, plan generator 12 generates, for each equipment 50, an operation plan that is in accordance with the timing for attaining the state.

Above-described risk preparation device 10 according to this embodiment includes information obtainer 11, plan generator 12, storage 13, and an outputter (plan executer 15, presentation controller 16). Presentation controller 16 is described in Embodiment 2. Information obtainer 11 receives prediction information D11 which predicts the occurrence of a risk. Storage 13 stores, in association with details of prediction information D11, details of preparation work for equipment 50 provided in building 40. Plan generator 12 generates, based on prediction information D11, operation plans for equipment 50 to implement the details of the preparation work by the time the risk occurs. The outputter outputs the operation plans.

According to this configuration, when prediction information D11 which predicts a risk, is received, equipment 50 are controlled to be able to implement details of preparation work to prepare for the risk, and because preparations to prepare for the risk are carried out, the effects of the risk can be reduced or avoided. Furthermore, if there is a margin between when prediction information D11 is issued to when the risk will occur, control of equipment 50 can be performed systematically, and operation plans can be generated so as to suppress loss in convenience and economical efficiency regarding the use of equipment 50.

Furthermore, it is preferable that storage 13 stores the types and levels of risks as details of prediction information, in association with details of preparation work.

According to this configuration, by determining the details of the preparation work with consideration to not only the type but also the level of the risk, a response that is suitable to the risk becomes possible.

In this embodiment, the outputter includes plan executer 15 which instructs operations to equipment 50 according to the operation plans. Therefore, control of equipment 50 that is in accordance with the operation plan is possible.

Equipment 50 may include a storage battery. In this case, the preparation work is to increase the battery residual above the upper limit value of the battery residual of the storage battery in normal times. Furthermore, equipment 50 may include a storage-type water heater which includes a hot water storage tank. In this case, the preparation work is to fill up the storage tank. In addition, equipment 50 may include a bath having an automatic hot water filling function. In this case, the preparation work is to fill up the bathtub. Alternatively, equipment may include a window or a ventilation hole. In this case, the preparation work is closing the window or the ventilation hole.

In all of these cases, preparation to prepare for the occurrence of the risk is possible, and thus it is possible to reduce or avoid the effects of the risk.

### Embodiment 2

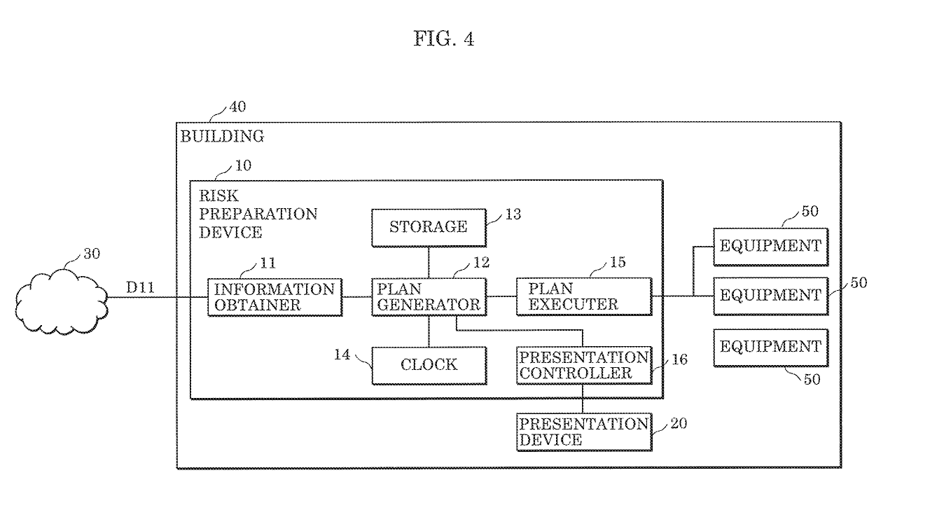

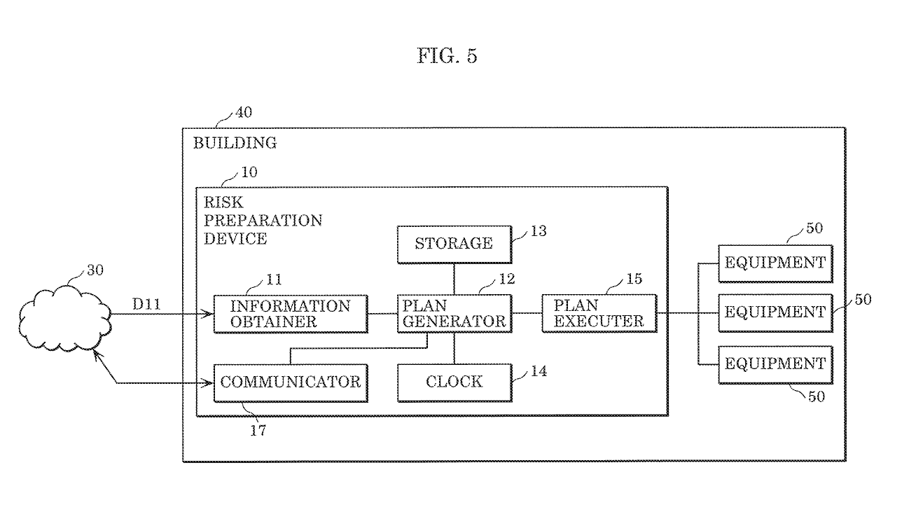

Risk preparation device 10 in Embodiment 1 is configured to control equipment 50 according to operation plans generated based on prediction information D11. In contrast, as illustrated in FIG. 4, risk preparation 10 in this embodiment is configured to present, on presentation device 20, the details of the operation plans generated based on prediction information D11.

Presentation device 20, though provided exclusively to risk preparation device 10, can be substituted by a general-purpose terminal device. Although presentation device 20 is integrated with the body of risk preparation device 30 when provided exclusively to risk preparation device 10, presentation device 20 can be provided as a separate body from the body of risk preparation device 10. Furthermore, the general purpose terminal device is selected from a smart phone, tablet terminal, personal computer, etc. When a general purpose terminal device is used as presentation device 20, risk preparation device 10 is provided with an interface (not illustrated) for transmitting and receiving of data with the general-purpose terminal device.

Risk preparation device 10 includes presentation controller 16, which serves as the outputter, for generating presentation information to be presented on presentation device 20 according to the operation plans generated by plan generator 12. Presentation controller 16 generates, based on the operation plan generated by plan generator 12, presentation information for presenting, to a user, the operations of equipment 50 in the period from when prediction information D11 is received to the time when the risk is predicted to occur. Specifically, presentation controller 16 is an outputter that outputs presentation information from risk preparation device 10 to presentation device 20. In the configuration example illustrated in FIG. 4, one of equipment 50 is not connected to risk preparation device 10, and thus the details of the operation plans are notified to the user through presentation device 20 so that the user operates the one equipment 50 according to the operation plans.

Furthermore, when combining with the configuration in which equipment 50 are caused to carry out the operation plans through plan executer 15 as in Embodiment 1, the details of the operation plans generated by plan generator 12 are preferably presented on presentation device 20.

It is sufficient that the presentation information be details indicating that equipment 50 are carrying out preparation work in preparation for the risk. Furthermore, the presentation information more preferably includes the state of progress of the preparation work. By indicating to the user, though presentation device 20, that preparation work to prepare for the risk is being carried out, it is possible to notify the user that preparation for the risk is in progress and thereby impart a feeling of security. Furthermore, by indicating the state of progress of the preparation work to the user, though presentation device 20, it is possible to notify the extent of the progress of the preparation work to the user and thereby impart a greater feeling of security. The rest of the configuration and operations in this embodiment are the same as in Embodiment 1.

In risk preparation device 10 in this embodiment, the outputter includes presentation controller 16. Furthermore, the outputter includes plan executer 15 and presentation controller 16. Plan executer 15 instructs operations to equipment 50 in accordance with the operation plans. Furthermore, presentation controller 16 presents, on presentation device 20, information regarding the operation plans. When the outputter includes plan executer 15 and presentation controller 16, presentation controller 16 preferably presents, on presentation device 20, the state of progress of preparation work of equipment 50 to which plan executer 50 has instructed operations.

According to this configuration, since the fact that preparation work is being carried out or the state of progress of the preparation work is indicated on presentation device 20, a feeling of security can be imparted to the user.

### Embodiment 3

When the preparation work that is prepared for a risk is charging a storage battery, filling water into a hot water storage tank or a bathtub, etc., resources supplied by a utility operator, such power, gas, and water, are consumed for the preparation work. Specifically, preparation work of this type reduces or avoids risk by storing storable resources in advance, before the risk occurs. Therefore, when this type of preparation work is carried out in a plurality of buildings 40, there is a possibility that demand for resources associated with the preparation work will exceed the supply of resources.

For example, depending on the details of an operation plan, a state arises where buying of electricity is carried out at a time zone where buying of electricity is not normally carried out, or a state arises where power that is normally for selling of electricity is used for charging the storage battery and selling of electricity is not carried out. In other words, there occurs at least one of a state where demand for power rises and a state where supply of power decreases. Therefore, when such a state occurs in a plurality of buildings 40, supply of power may become insufficient for the demand.

In this embodiment, when an operation plan which affects demand and supply of resources is generated in the case were preparation work to prepare for a risk is carried out in building 40, the operation plan is notified to another party concerned with the demand and supply of resources to reduce the possibility of demand for the resource exceeding supply of the resource. Here, another party concerned with demand and supply of resources refers specifically to at least one of a supplier that supplies a resource and a consumer that consumes the resource. A supplier of a resource normally corresponds to an operator that supplies a resource. Furthermore, a consumer of a resource corresponds to a user in another building 40 including risk preparation device 10. However, the actual notification is made to another device such as a terminal device managed by an operator, a terminal device or risk preparation device 10 managed by a user.

By notifying the operation plan to the supplier of a resource, the resource supplying side can adjust the supply of the resource to match the demand because it is aware of the amount of supply of resources. Furthermore, by notifying the operation plan to consumers of the resource, consumers of the resource can mutually adjust periods of consumption, thereby making it possible to even-out the demand for resources. In other words, consumers of the resource can mutually adjust operation plans to mitigate a shortage in the supply of resource.

In order to perform the above-described operation, risk management device 10 in this embodiment includes communicator 17 which communicates with another device. Communicator 17 has a function of notifying the operation plan generated by plan generator 12 to another device that affects demand and supply of a resource. Furthermore, communicator 17 has a function of receiving an operation plan generated by another device.

It should be noted that in this embodiment, aside from generating an operation plan, plan generator 12 has a function of referring to an operation plan received from another device via communicator 17, and adjusting the operation plan to even-out the demand for a resource. Here, if the period from when prediction information D11 is received to when the risk will occur is sufficiently long, it is possible to even-out the demand for resources with an adjacent building 40. On the other hand, if the period from when prediction information D11 is received to when the risk will occur is relatively short, it becomes difficult to adjust operation plans with the adjacent building 40. In such a case, operation plans can be adjusted to even-out the demand for resources if the adjustment is between building 40 in an area where the risk is likely to occur and building 40 in an area where the risk is not likely to occur.

Furthermore, since the processing load on plan generator 12 becomes significant when there are many buildings 40 with which operation plans are to be adjusted, the range for mutually adjusting operation plans is preferably determined beforehand according to a predetermined rule. This rule is determined according to conditions such as the period from when prediction information D11 is issued to when the risk occurs, the details of preparation work, the probability that the risk will occur, etc.

A case is assumed where the resource is power, and a request to conserve power is received from the utility operator such as a power company or service provider. This type of request is sent from the utility operator as demand response information (hereafter referred to as DR information). Risk preparation device 10 receives DR information via communicator 17. Here, a communicator (first communicator) having a function of notifying the operation plans generated by plan generator 12 to another device, and a communication (second communicator) having a function of receiving the DR information may be provided separately, However, in this embodiment, communicator 17 having both functions is provided.

The DR information is information including a period in which power received by building 40 is to be reduced in order to suppress the demand for power. In other words, the DR information includes a period in which power conservation is requested. The utility operator tries to reduce demand during this period by setting a high unit cost for electricity charges or providing incentives to people who cooperate. Furthermore, there are also cases where the DR information includes a target value for reduction of power.

The period for power conservation included in the DR information is a period where supply of power is predicted to be tight. In this embodiment, the period from when prediction information D11 is issued to when a risk will occur is considered to be the period where supply of power is tight. As such, the utility operator, which is the power supply side receives prediction information D11 in the same manner as risk preparation device10, and issues DR information based on prediction information D11.

In risk preparation device10 in this embodiment, plan generator 12 generates operation plans for equipment 50 based on prediction information D11, but reconsiders the generated operation plans when DR information is received. Specifically, plan generator 12 adjusts the operation plans to increase the supply of power and reduce demand for power during the period indicated in the DR information. Although the adjustment of the operation plans can be performed independently by risk preparation device 10 in one building 40, it is preferable that risk preparation devices 10 in a plurality of buildings 40 perform the adjustment in coordination with each other. The rest of the configuration and operations in this embodiment are the same as in Embodiment 1 or Embodiment 2.

Risk preparation device 10 preferably includes a first communicator (communicator 17) which notifies operation plans to other devices.

With this configuration, the operation plans are notified to other devices, and thus, when the preparation work for the risk will affect demand and supply of resources, at least one of demand and supply of resources can be adjusted so that the demand and supply of resources match.

Furthermore, risk preparation device10 may include a second communicator (communicator 17) which receives, from the other devices, information requesting the adjustment of the operation plans. In this case, plan generator 12 adjusts the operation plans in the case where second communicator (communicator 17) receives information requesting for adjustment of the operation plans.

According to this configuration, when there is a possibility that demand for resources will increase due to preparation work for a risk, and adjustment of the operation plans is requested from the resource supply-side, the demand for resources can be adjusted so that the demand and supply of resources match.

It should be noted that the foregoing embodiments are examples of the present invention. As such, the present invention is not limited by the foregoing embodiments, and it should be obvious that, aside from the foregoing embodiment, various modifications according to designs, etc., are possible so long as they are within the scope of the technical concept of the present invention.

It should be noted that general and specific aspects of the present invention may be realized by a system, a method, an integrated circuit, a computer program or a computer-readable recording medium such as a CD-ROM, and may be realized by an arbitrary combination of a system, a method, an integrated circuit, a computer program, and a recording medium.

For example, the present invention may be realized as a program for causing a computer to function as risk preparation device 10.

Furthermore, the present invention may be realized as risk preparation system in which the structural components of risk preparation device 10 are distributed among a plurality of devices. Although such a risk preparation system, for example, includes a terminal device which includes a plan generator and an outputter (presentation controller), and a server which includes an information obtainer and a storage, the distribution of the structural elements included in risk preparation device 10 to the plurality of devices is not particularly limited.

1. A risk preparation device comprising:
an information obtainer which obtains prediction information predicting an occurrence of a risk;
a storage which stores, in association with details of the prediction information, details of preparation work for equipment provided in a building;
a plan generator which generates an operation plan for the equipment based on the prediction information, to implement the details of the preparation work by a time the risk occurs; and
an outputter which outputs the operation plan.

2. The risk preparation device according to claim 1,
wherein the storage stores a type and a level of the risk as the details of the prediction information, in association with the details of the preparation work.

3. The risk preparation device according to claim 1,
wherein the outputter includes a plan executer which instructs an operation to the equipment according to the operation plan.

4. The risk preparation device according to claim 1,
wherein the outputter includes a presentation controller which presents, on a presentation device, information regarding the operation plan.

5. The risk preparation device according to claim 1,
wherein the outputter includes:
a plan executer which instructs an operation to the equipment according to the operation plan; and
a presentation controller which presents, on a presentation device, information regarding the operation plan, and
the presentation controller presents, on the presentation device, a state of progress of the preparation work regarding the equipment to which the plan executer has instructed the operation.

6. The risk preparation device according to claim 1, further comprising
a first communicator which notifies the operation plan to another device.

7. The risk preparation device according to claim 1, further comprising
a second communicator which receives, from another device, information requesting adjustment of the operation plan,
wherein the plan generator adjusts the operation plan when the second communicator receives the information requesting the adjustment of the operation plan.

8. The risk preparation device according to claim 1,
wherein the equipment includes a storage battery, and
the preparation work is to increase a battery residual above an upper limit value of the battery residual of the storage battery during normal times.

9. The risk preparation device according to claim 1,
wherein the equipment includes a storage-type water heater having a hot water storage tank, and
the preparation work is to fill up the hot water storage tank.

10. The risk preparation device according to claim 1,
wherein the equipment includes a bath having an automatic hot water filling function, and
the preparation work is to filling up a bathtub of the bath.

11. The risk preparation device according to claim 1,
wherein the equipment includes one of a window and a ventilation hole, and
the preparation work is closing the one of the window and the ventilation hole.

12. A risk preparation method comprising:
obtaining prediction information predicting an occurrence of a risk;
storing, in association with details of the prediction information, details of preparation work for equipment provided in a building;
generating an operation plan for the equipment based on the prediction information, to implement the details of the preparation work by a time the risk occurs; and
outputting the operation plan.

13. A risk preparation system comprising:
an information obtainer which obtains prediction information predicting an occurrence of a risk;
a storage which stores, in association with details of the prediction information, details of preparation work for equipment provided in a building;
a plan generator which generates an operation plan for the equipment based on the prediction information, to implement the details of the preparation work by a time the risk occurs; and
an outputter which outputs the operation plan.

14. The risk preparation system according to claim 13, comprising:
a server including the information obtainer and the storage; and
a terminal device including the plan generator and the outputter.
